(19) United States
(12) Patent Application Publication
(10) Pub. No.: US 2016/0062576 A1
(43) Pub. Date: Mar. 3, 2016

(54) PRESENTATION APPARATUS AND METHOD PROVIDING COMPOSER CONTENT CONTROL AND PRESENTER SELECTION FLEXIBILITY FOR CRAFTING PRESENTATIONS

(71) Applicant: Perfect Pitch Productions, LLC, Marietta, GA (US)

(72) Inventor: Todd Simon, Atlanta, GA (US)

(73) Assignee: PERFECT PITCH PRODUCTIONS, LLC, Marietta, GA (US)

(21) Appl. No.: 14/843,966

(22) Filed: Sep. 2, 2015

Related U.S. Application Data
(60) Provisional application No. 62/045,333, filed on Sep. 3, 2014.

(51) Int. Cl. G06F 3/0482; G06T 11/60; G06F 17/24; G06F 3/0484

(52) U.S. Cl. CPC G06F 3/0482; G06F 3/04842; G06T 11/60; G06F 17/24

(57) ABSTRACT

A system for creation of content and assembly of selected content for a presentation, with a composer that creates and stores content modules in a library, each content module locked from change except by the composer, and a communications network linking the library with a performer that accesses selected content modules for a non-linear pitch presentation of the content therein, the presentation tracked and reported for a targeted development to modify and improve the presentation based on the presentation failing to meet a pre-determined criteria. A presentation method is disclosed.

The present application claims the benefit of U.S. provisional patent application Ser. No. 62/045,333, filed Sep. 3, 2014, and incorporated herein by reference in its entirety.

### TECHNICAL FIELD

The present invention relates to presentation apparatus and methods. More particularly, the present invention relates to apparatus and methods for composers to establish and control presentation content while providing presenters with selection flexibility to craft and conduct presentations for particular audiences using the content.

### BACKGROUND OF THE PRESENT INVENTION

Sales representatives engage in a wide variety of activities including research, contact, presentations, and follow-up in providing information as to client goods and services to prospective customers for such products. Commonly, the presentation of the information to a prospective customer is known as the “pitch”. The pitch includes different presentation media and techniques. These include as non-limiting examples written materials and brochures, video, audio, samples, and the like, provided as deliverables by the salesman for the prospective customer. The pitch materials are delivered through various contact environments including mail, electronic mail, social media, and personal presentation.

Often sales representatives conduct pitch presentations in person and use presentation systems to assemble a sequence of electronically digitized displayable images for use in the pitch presentation. The sequenced assembly is generally known as a “deck”.

While the sales representatives engage in their sales activities, there are drawbacks to current pitch presentations and pitch techniques that limit sales and/or result in need for follow-up and further pitch activities to bring about successful closing of sales opportunities for the goods and services to be sold to the prospective customer. Pitch presentations often involve linear presentation of information the salesman wants to provide, or believes that his employer wants him to provide. While this may be an accepted well and good approach, linear presentations often are not responsive to directional signals that develop during the presentation. Indeed, the salesman or sales team may be so focused on the information they want to provide, that the presenter misses the interaction signals of the underlying interests of the prospective customer as to proposed goods or services subject of the pitch. These signals include attention details of the audience, such as questions, attention, or responsive or direct indications of the content to be address. A salesman wedded to his perception of the presentation may miss such opportunities to adjust the presentation responsively.

In addition, sales representatives developing pitch decks spend time on administrative tasks of locating, selecting, and organizing company marketing materials and collateral, and digitizing such materials if not already in an electronic form. Such material is developed typically by a marketing group for projecting a common company brand and image with unified approved standards for presentation materials, art work, and text. A salesman believing modification of the content is necessary to result in materials more tailored to the perspective client may spend time re-phrasing sales materials and developing modified or new graphics. Time, money, and effort is thus expended in developing decks considered to be more suitably customized for particular prospective customers. However, poor presentation design and implementation leads to brand erosion and unclear market presence as each salesman promotes a company story different from that of other sales representatives and possibly different from the marketing plans and goals of the company. Instead, the sales representatives would beneficially gain from selected specific training and study of marketing materials that promotes a unified view of the employer, explains the products and services offered to prospective customers, and develops the sales representatives capability for delivering a non-linear presentation during which the sales representative interacts engagingly with the prospective customer to address and respond to the audience dynamics of the pitch presentation.

Management also needs meaningful tracking of sales activities and results. The absence of correlating pitch results with sales activities on pitches, with pitch content, and with sales representative activities in developing, practicing, and delivering pitches, results in inefficient use of sales representatives time and budget. Meaningful evaluation and correlation of pitches and resulting sales performances provides information useful to management. Training programs may then focus on assisting and developing the sales representatives in specific areas of sales activities.

Accordingly, there is a need in the art for an improved apparatus and method of managing marketing pitches or presentations to prospective customers by preparing and controlling content available for marketing pitches while providing sales representatives with flexibility for content selection and sequence in order to craft customized pitches that may be accessed for non-linear marketing presentations to particular prospective customers and monitoring of sales pitch outcomes, to increase the volume of sales closed by sales representatives making the presentations. It is to such that the present invention is directed.

### BRIEF SUMMARY OF THE INVENTION

The present invention meets the need in the industry by providing a systematic methodology for controlled creation of content and organization of selected content for presentations, comprising the steps of:

(a) creating with a composer, and storing, a plurality of content modules, each content module containing at least one content item and upon storing thereof locking the content module from change except by the composer; and

(b) linking the plurality of content modules to a performer for selective access and display in a non-linear presentation,

whereby the locked content provides assurance of consistent content presentation while allowing for non-linear presentation responsive to a discussion between a presenter and a presentee.

In yet another aspect, the present invention provides a system for controlled creation of content and assembly of selected content for a presentation, comprising a composer configured for creating a content module containing at least one content item and for storing the created content module in a library holding a plurality content modules, each content module locked from change except by the composer and a communications network linking the library with at least one performer configured for accessing the plurality of content modules and for displaying content modules selectively for review and selection for including in one of a plurality of presentation assembly maintained in the library. The performer further configured for presenting the presentation assembly in a non-linear manner and for tracking the presentation of the presentation assembly according to one or more presentation criteria. A reporter configured for receiving a value representative of the respective one or more tracked presentation criteria associated with the presentation and for determining an occurrence of a gap in the presentation based on the respective value of the tracked presentation criteria not meeting a predetermined standard. A targeted development is responsive to the gap for modifying the presentation of the presentation module.

In yet another aspect, the present invention provides a networked system for presentation content configuration, usage in a presentation, and reporting based on presentation criteria, comprising a microprocessor server device configured with an electronic memory device having a plurality of content elements that each comprise one or more content items, a plurality of content modules each comprising at least one content element, a plurality of a presentation assembly each comprising one or more selected ones of the content modules, and a status file of one or more presentation criteria values associated with a respective one of a plurality of presentations of the presentation assemblies. A communications network is accessible to and communicating with the electronic memory device by (i) a composer configured for maintaining the plurality of content elements and the plurality of content modules, each content module locked from change except by the composer, (ii) a performer configured for maintaining the plurality of presentation assemblies, for display of a selected presentation assembly as a non-linear presentation displaying the content modules selectively, and for reporting to the status file a value representative of a respective one of the presentation criteria associated with the presentation for tracking of the presentation, and (iii) a reporter configured for evaluating the presentation criteria values of the presentation relative to a predetermined presentation standard for each of the respective presentation criteria and reporting thereon. A targeted development responds to a gap in the presentation based on the tracked presentation criteria not meeting the predetermined standard thereof for modifying the presentation of the presentation assembly.

Objects, advantages, and features of the present invention will become apparent upon a reading of the following detailed description in conjunction with the drawings and the appended claims.

### BRIEF DESCRIPTION OF THE DRAWINGS

FIG. 1 illustrates a schematic view of an apparatus for presentation optimization in accordance with the present invention to improve sales presentation effectiveness with a composer to create content modules, a performer to select and sequence content modules for a pitch presentation to a particular prospective customer and a reporter to track pitch outcomes.

FIG. 2 illustrates a schematic view of an illustrative embodiment of the apparatus shown in FIG. 1 for presentation optimization in accordance with the present invention, in which the composer establishes content modules and/or pitches for the performer to choose or selectively assemble and sequence in a pitch to the particular prospective customer.

FIG. 3 illustrates a control screen for the composer to create or edit content modules in accordance with the present invention.

FIG. 4 illustrates a performer screen for a presenter during a pitch to a prospective customer.

FIG. 4A illustrates a call-out window for during-presentation generation of an electronic communication forwarding discussed content to an addressee.

FIG. 5 illustrates an embodiment of a composer for add, change, or delete functions for content elements, for content modules and for pitch modules, in accordance with the present invention.

FIG. 6 illustrates an embodiment of a composer screen for maintaining a library of content elements and content modules having at least one content element, in accordance with the present invention.

FIG. 7 illustrates an embodiment of a performer screen for maintaining a library of pitches having one or more content modules for presentations, in accordance with the present invention.

FIG. 7A illustrates an alternate embodiment of a pitch creation window.

FIG. 7B illustrates a window for creating a pitch immediately using selected source files.

FIG. 8 illustrates an embodiment of a performer screen for starting and presenting a presentation of a pitch.

### DETAILED DESCRIPTION

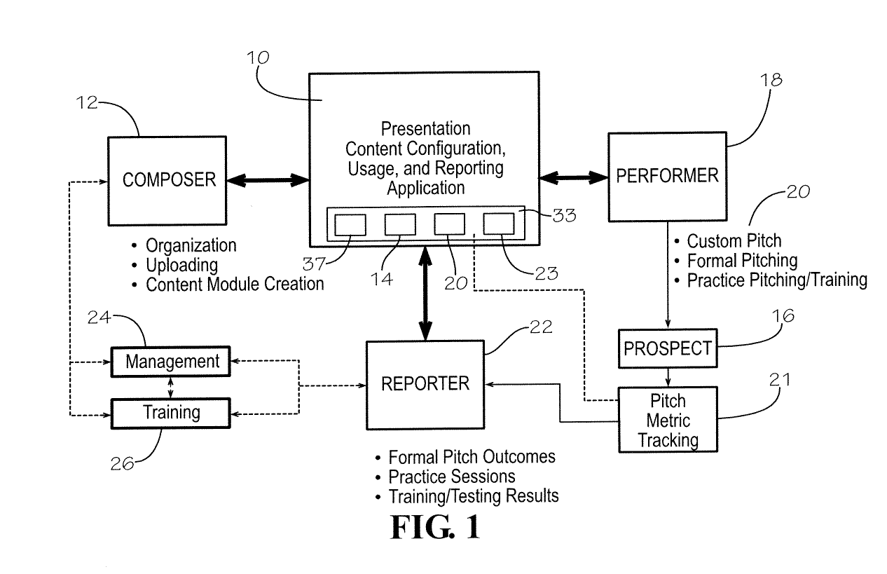

With reference to the drawings, in which like parts have like identifiers, FIG. 1 illustrates a schematic view of a presentation content configuration, usage, and reporting apparatus or system 10 having a composer 12 that configures and organizes a plurality of standards-consistent content modules 14 for use in live marketing presentations or pitches through which sales representatives seek to sell goods and services to a plurality of prospective customers 16, a performer 18 that assembles a plurality of custom marketing presentations or pitches 20 for a particular one of the prospective customers 16 using at least a selected one of the content modules 14, and a reporter 22 that tracks pitch metrics 21 and reports on pitch presentation and performer activities and outcomes. The apparatus 10 leads to increased volumes of closed sales for sales representative activities arising from the efficient directed and responsive non-linear presentations of the pitch 20 using the selected content modules 14 by the sales representatives while monitoring and evaluating performance in order to improve the content modules 14 and through training, such as best practices, to improve sales presentation effectiveness.

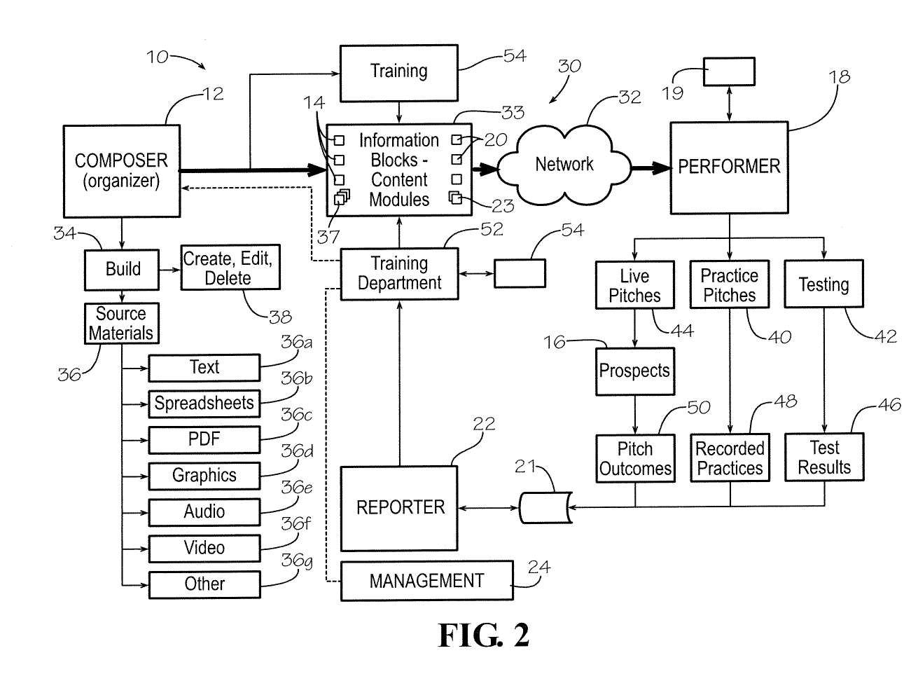

FIG. 2 illustrates an embodiment of the apparatus 10 that operates within a distributed networked system 30. The composer 12 organizes and creates the content modules 14 for selective inclusion in the marketing pitches 20 assembled by the performer 18 for use by sales representatives making the marketing presentation to the prospective customer 16. In addition, the composer 12 may define pre-assembled pitches 23 for use by the performer 18; for example, a standard “about us” presentation or pitch. Unless otherwise noted, the following refers to pitches as both performer created pitches 20 and composer created pitches 23. The performer 18 uses one of the pre-assembled pitches 23, a prior pitch 20, or assembles selected ones of the content modules 14 into the pitch for use in practicing 40 the presentation using the customized marketing pitch, for live presentation 44 of the customized marketing pitch to the prospective customer, or for training 42 in presenting marketing pitches. The application database includes metrics information about pitch outcomes, pitch practices and testing, as discussed below. A reporter 22 tracks and reports on sales representative performance and outcomes in order to develop training programs to improve the effectiveness of the sales representative in using the pitches 20. The reporter 22 may be configured for filtering the performance data (i.e., reporting by presenter (sales representative, for example), dates, outcomes, activities, or other tracked information and criteria), for reporting to management. Such tracking may include objective and subjective criteria such as time usage, speaking rate, listening rate, opening, and closing. The reports may be used by management 24, for example, to facilitate training 26 of the sales representative in delivering presentations and in using the performer 18 and to assist the composer 12 to improve the content modules 14.

A communications network 32 provides access through the respective application (composer 12, performer 18, and reporter 22) to the content modules 14, the pitches 20 and to performance activity of the sales representatives or presenters using the pitches 20, 23. The content modules 14 uploaded by the composer 12 are accessible from a database of the apparatus 10, such as a memory device resident on a microprocessor server for the application 10, cloud storage, or other secured memory device networked for access by the respective composer 12 and performer 18 applications. The applications may also be accessible through off-line microprocessor devices. For example, the pitch 20 may be accessible to a sales representative via an electronic memory device 19 connected, linked, or attached for communication with a microprocessor based device, personal communications device, tablet, personal computer, or microprocessor controller. This permits the presentation by the sales representative independent of network bandwidth limitations; for example, selective presentation of a video as a content item of the pitch 20, without possible bandwidth delays.

The composer 12 collects, organizes and uploads marketing content (or source materials) 36 as content elements 37 to an electronic database 33 or library subsequent use in creating or editing content modules 14. The marketing content 36 may include text documents 36a, spread sheets 36b, portable format documents 36c (for example, typically graphics and text, such as product technical brochures), graphics 36d, audio 36e, video 36f, and other content materials 36g, in electronic digital format. The marketing content 36 preferably is consistent with company branding and marketing standards with vetting coordinated by the marketing department (that is, in accordance with company approved font, colors, styles, composition, and content such as information provided by company departments responsible for the goods or services associated with or subject of the marketing content). The marketing content 36 however may include third party documents, graphics, images, brochures and the like. The composer 12 uses any of the marketing content 36 to build 34 one or more content modules 14. This building process involves 38 creating, editing, and possibly deleting content and content modules 14 that use the marketing content 36. The composer 12 uploads the created or edited content modules 14 to the content database. The content modules 14 are locked from modification except through the composer 12. The composer 12 may also create, edit, and modify assembled pitches 20 and uploads those to the content database. Each assembled pitch 20 comprises one or more selected ones of the content modules 14.

The performer 18 accesses the pre-assembled pitches 20 or the available content modules 14 to assemble a custom pitch 20, which content modules are selected and sequenced by a sales representative for the presentation to the prospective customer 16. The performer 18 enables the pre-assembled pitch or customized pitch 20 to be used in pitch practice 40, in tests 42 for sales skills evaluations and monitoring, and for live pitch presentations 44 to the prospective customer 16. The activities available through the performer 18 are monitored and recorded in the pitch metrics tracking database 21, including test results 46, practice details 48, and pitch outcomes 50. Further, the sales representative may use the performer 18 to re-sequence and/or add content modules 14 in the pitch 20 that the particular sales representative authored, or delete selected content modules 14 from pitch 20 that the particular sales representative authored. The performer 18 however is incapable of modifying the content modules 14. The performer 18 may also be restricted from editing or changing pitches 23 created by the composer 12. Any proposed change or modification to the content module 14, or to one of the pre-assembled pitch 23, may be submitted to the marketing group or other department responsible for operational use of the composer 12 for consideration. Typically, this involves coordination, discussion and evaluations involving marketing, sales and product departments of the company.

The reporter 22 provides timely information from the application database 21 as to sales representative activity and pitch outcomes. The pitch metrics tracking database 21 tracks test results 46, pitch practice sessions 48 (such as date and time involved in practice for a live pitch), and pitch outcomes 50. In an alternate embodiment, the reporter analyzes the metrics of the tracked criteria and may provide a report of the analysis, alternatively, a summary of the metrics, and may provide recommended training and practices to develop the skills of the presenter. Filters may selectively focus on comparative information. For example, less successful sales representatives may be readily identified, evaluated, and counseled as to practices undertaken before a live pitch performances is made. Additional training 54 for a sale representative may be directed from a training department 52 to develop sales skills The training department may create or modify training classes 54 for sales skills development. The training department may work together with the marketing department, management, and sales departments in developing and modify training courses.

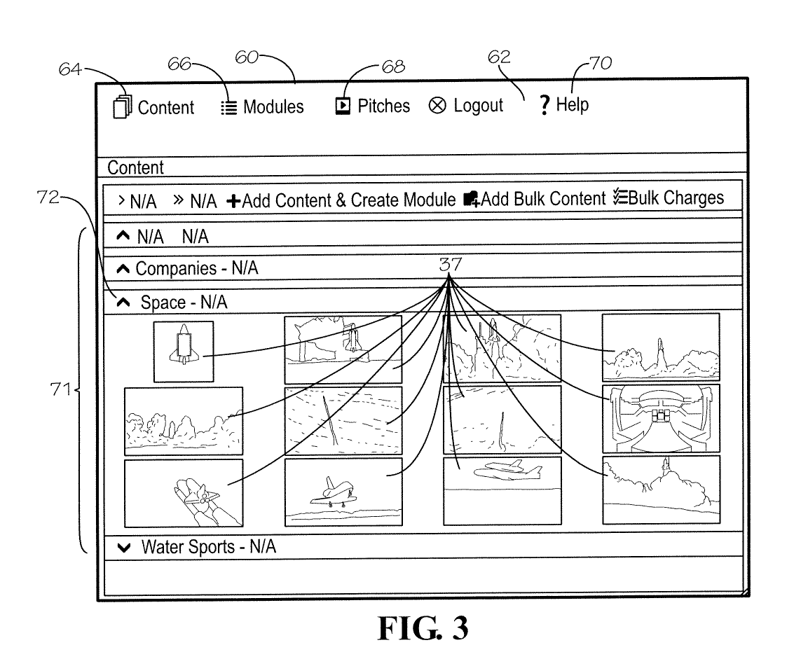

FIG. 3 illustrates a control screen 60 for the composer 12 to create, edit, or delete, one of the plurality of the content modules 14, for use by the performer 18 in a respective pitch 20 for a presentation made by a sales representative to the prospective customer 16 in accordance with the present invention. The control screen 60 has a command ribbon 62 with command links (direct and active or in an alternate embodiment, a drop-down menu) displaying a content access button 64 to access content 36, a content module button 66 for access to content modules 14, a pitch access button 68 for access to pitches 23 created by the composer 12 or pitches 20 created by the performer 18, a help button 70 for accessing on-line help, and a button for logging off. FIG. 3 further displays a list 71 of the content elements 37 selectively available through the content access command 64 to the composer 12 for including in a new content module 14 or for adding to an existing content module. Selecting an open/close button 72 included in the command bar for the listed content element displays 73 the content or closes the display of content.

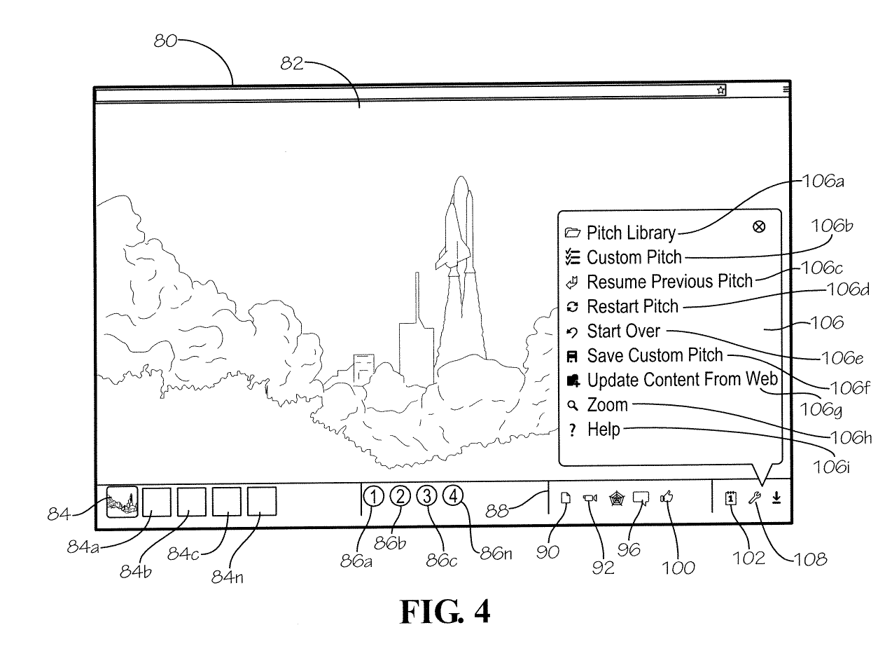

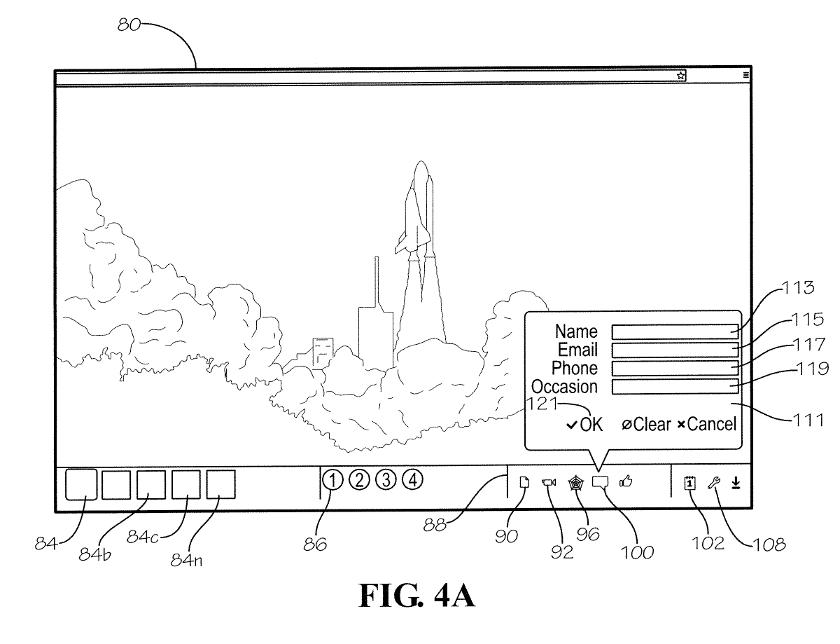

FIG. 4 illustrates a screen 80 displayed by the performer 18 during a presentation of a respective pitch 20, for example, during a practice mode 40 in preparation for a live presentation or live mode presentation 44 to the prospective customer 16. The screen 80 includes a display window 82 for display of the content as well as displaying pitch module icons 84 and content buttons 86. The pitch module icons 84 represent a respective one of each of the content modules 14 included in the pitch 20. The display sequence of the icons 84 is in the sequence selected during creation or editing of the pitch 20. Each content module 14 includes at least one content image represented by the content buttons 86, 86a, 86b, . . . 86n. The content is displayed when the respective content button 86 is selected. The content module 14 may include one or more of the content 36 as a content component generally indicated by a field 88 of content component icons. The content components associated with the content module 14 may be accessed through the respective icon that includes attachment or document 90, video 94, and note 96. Other commands accessible to the performer 18 include a calculator, a content send window 100, a table of contents, and a help button. These tools or operating command buttons are accessed from a pop-up window 106 responsive to a tools button 108 (symbolized in the illustrated embodiment with a wrench). These other tools include an access pitch library button 106a, a custom pitch button 106b, a resume pitch 106c, a restart pitch 106d, a start over 106e, a save pitch 106f, an update button 106g, a zoom 106h, and the help button 106i.

During a pitch presentation, the sales representative may actively switch the performer 18 between the two or more content modules 14 by using a selector such as a conventional mouse, pointer, or control pad for moving a screen curser element, to select the respective one of the content module icons 84, 84a, 84b, 84c, 84n. The performer 18 then displays the contents of the selected module on the display 82 and displays the content buttons 86a, 86b, 86c, . . . 86n for each of the content elements in the selected content module. The screen 80 also displays the one or more content icons 88 for the attachments associated with content element.

During the pitch presentation, the sales representative may direct the performer 18 to switch among the content elements 37 by selecting one of the content buttons 86a . . . 86n. This involves moving the mouse or control pointer to the particular item 86 and selecting. The content items 36 available for the respective content element are shown as highlighted or illuminated access buttons in the content field 88; if a content component is not available, the icon for the type of component is darkened or faded. The performer 18 readily and selectively accesses the respective available attachment or document 90 (such as portable format document, or if enabled, a text document or spread sheet), video 92 or note 96 with mouse or courser control. The performer 18 presents the selected content component in its native application (i.e., a .pdf document is presented in Adobe READER application).

With reference to FIG. 4A, the illustrated embodiment provides a call-out window 111 when the presenter selects the content send button 100. The window 111 provides a name field 113, an email address field 115, and optionally entered phone number field 117 and occasion field 119 (for example, text indicating trade show contact, on-line meeting, or other description.) An OK button 121 saves the information and generates an electronic communication such as an email with the content as an attachment. The call-out window 111 includes a close button and a cancel button. The reporter 22 collects the contact information and management reporting selectively shows the information, the content sent, and the date and time, providing effective tradeshow lead gathering and reporting capability.

The agenda button 102 displays the content of the pitch in a tabular annotated form for selective access.

The present invention thereby provides for non-linear pitch presentations. The familiarity of the sales representative (presenter) with the content included in the pitch 20 facilitates rapid and responsive non-linear movement among the content modules 14 (accessed by the content buttons 84) and each associated content element 37 thereof (accessed by the content component 88), as well as switching between pitches 20 as may be appropriate during a presentation based on the dynamic interaction of the sales representative and the prospective customer. The sales representative 14 addresses information sought by the prospective client 12 rather than linearly proceeding through a pitch presentation. In that regard, the sales representative may select other individual content modules during operation of the performer 18 in the live presentation mode so as to create a new pitch on the fly. This may be accomplished by accessing 106a the pitch library. The sales representative thus may find and display other content for which the audience may be asking outside of the information in the pitch being presented. The sales representative is thereby provided with the flexibility to respond to presentation dynamics.

The illustrated embodiment enables directed and controlled presentations in which each pitch 20 may have up to eight content modules 14, with each content modules 14 having up to twenty content images 86, and each content module 14 having separate videos and attached documents for access and display during a presentation. The limitations are based on reasonable human factors of the volume of different information that are readily handled, but may be changed for particular requirements. Alternatively, if a sales representative believes access to more content modules 14 is necessary, a second pitch 20 may be created. The apparatus 10 however facilitates concise, directed and orderly presentations (and thus the limitation on available content modules in a pitch) while offering non-linear flexibility and responsiveness based on the dynamic interactions of presenter/presentee audience and encourages discussion and interaction with the goal of achieving closed sales.

In an alternate embodiment, the performer 18 may further facilitate presentation of a product bid or quotation to a prospective customer 16. This feature is designated by a calculator icon illuminated on the display (for example, a bright color rather than faded or dark color). Selecting the calculator icon brings up a spread sheet document prepared for entry of a quantity for a particular product. The spreadsheet document and calculator feature is created by the composer 12 as a content element of a content module 14.

At the close of the presentation, the sales representative provides the pitch outcome 50 (i.e., closed sale, needs follow-up, or other status of the pitch) for entry to the reporter 22. In alternate embodiments, the reporter may receive the ratings of other of the tracked criteria. In an exemplary embodiment, the performer 18 does not permit operation in a subsequent Live Presentation mode until the sales representative makes record of the pitch outcome of the previous (still open) live presentation pitch. An alternate embodiment may be configured to restrict use of the practice mode of the performer 18 so the sales representative may not avoid updating the prior live presentation. A ‘practice mode’ graphic is displayed at the top of the performer screen when the performer 18 is being used in the practice mode. The sales representative would not want such to be viewed by a prospective customer. This assures that the sales representative uses the performer 18 for live presentations properly while also reporting sales outcomes to management.

More particularly, the apparatus and method disclosed herein provides for marketing personnel to prepare with the composer 12 the content modules 14 and pitches 23 with approved and consistent branded information related to a company's goods and services which are the subject matter of a sales presentation by sales representatives to prospective customers 16. The content modules 14 and pre-assembled pitches 23 are fixed and locked from changes by sales representatives. The sales representative selects pre-assembled pitches 23 or content modules 14 for use in the customized pitches 20. Rather than regenerating content or spending time searching for marketing materials and collateral, the sales representative may use available time to become familiar with existing content that provides a uniform message consistent with the branding and marketing standards of the company. The sales representative may access the pitch in the practice session 40 or in the live presentation 44 to the prospective customer 12. The practice session 40 enables the sales representative to become familiar with the content components and use of the navigation buttons 84, 86, 88 for moving selectively through the presentation. This facilitates non-linearly progressing through the pitch based on comments and questions posed by the prospective customer during the pitch presentation.

The presentation apparatus or system 10 improves the effectiveness of sales pitch presentations made by sales representatives using presentation optimization features for accessing organized content modules 14 into pitches 20. The performer 18 operates to select from the library of pre-existing pitches 20 or select and sequence content modules 14 for a tailored pitch 20 for the prospective customer 16. The application database 33 receives information 21 about pitch outcomes 50, pitch practices 48 and testing 46. The reporter 22 tracks and reports on sales representative performance and outcomes in order to develop training programs to assist the effectiveness of the sales representative in using the pitches 20 prepared by the performer 18. The reporter 22 may be configured for filtering the sale performance data (i.e., reporting by sales representative, dates, outcomes, activities, or other tracked information), for reporting to management. The reports may be used by management 24, for example, to facilitate training 26 of the sales representatives in conducting presentations and in using the performer 18 and to assist the composer 12 to improve the content modules 14.

The apparatus 10 facilitates sales effectiveness through the directed presentation development process using content collected and organized by the composer 12 in creating and editing content modules 14 and pitches 20. Sale representatives use the performer 18 to select pre-existing pitches 20 or to select and sequence content modules 14 for pitches 20. A number of sales representatives may gainfully use the performer 18 for preparing pitches 20. However, a sales representative may not modify the pitch 23 that was authored the composer 12 or by another sales representative. In an alternate embodiment, a sales representative my upload a custom pitch to the composer 12 for review and possible broadcast to other sales representatives. Management 24 may track sales outcomes 50 and uses performance information to develop targeted training for further development of the sales representatives in developing and conducting pitches to prospective customers.

While the present apparatus 10 is illustrated in a SAAS environment, the apparatus may be gainfully used in a private communications and hardware network and the separate composer 12, performer 18, and reporter 22 applications may operate on remote microprocessor-based devices such as computer workstations, portable microprocessor devices including laptop personal computers, tablets, mobile communication devices, and intelligent communication devices.

The following provides a disclosure of an illustrative embodiment of a presentation system in accordance with the present invention including the composer 12 for uploading marketing content and for creating and editing content modules and pitches 23 and the performer 18 application for creating, editing and presenting pitches 20. The system 10 readily integrates the dedicated composer 12 application for composing content modules and pitches 23 such as by a marketing group; the dedicated pitch performer 18 that provides presenters/sale representatives access to the pre-existing pitches 20 and to the content modules 14 to sequence and organize pitches to be made to prospective customers 16; and the reporter 22 for reporting collected pitch metrics. The performer application 18 operates selectively in modes for pitch practice 40 and for live pitches 50. The application 10 monitors sales pitch outcomes by the sales representatives for evaluation according to sales representative, outcome type, date of activity, and type of activity (practice or live).

In an illustrative embodiment, the present networked system 10 for presentation content configuration, usage in presentations, and reporting of presentations based on evaluated presentation metrics improves sales presentation effectiveness for closing sales. The system 10 facilitates non-linear delivery at an appropriate time during live face-to-face presentations 44 of content controlled for uniformity and consistency across presentations. The system 10 thereby enables the performer to follow the direction of the presentation conversation with supporting content in the non-linear manner to engage the audience/participants in a powerful and effective manner. The system 10 includes the microprocessor server device configured with an electronic memory device having (i) the plurality of content elements that each comprise one or more content items, (ii) the plurality of content modules 14 each comprising at least one content element 36, (iii) the plurality of the presentation assembly 20 each comprising one or more selected ones of the content modules 14, and (iv) the status file of one or more presentation criteria values associated with the respective one of the plurality of presentations of the presentation assemblies. A communications network accessible to and communicating with the electronic memory device by (i) the composer 12 configured for maintaining the plurality of content elements 36 and the plurality of content modules 14, each content module locked from change except by the composer, (ii) the performer 18 configured for maintaining the plurality of presentation assemblies, for display of the selected presentation assembly 20 as a non-linear presentation displaying the content modules 14 selectively, and for reporting to the status file a value representative of the respective one of the presentation criteria or outcomes associated with the presentation for tracking of the presentation, and (iii) the reporter 22 configured for evaluating the presentation criteria values of the presentation relative to the predetermined presentation standard for each of the respective presentation criteria and reporting thereon. The targeted development 26 responsive to a gap in the presentation based on the tracked presentation criteria not meeting the predetermined standard thereof enables modifying a subsequent presentation 44 of the presentation assembly for improved effectiveness.

The composer 12 collects content items 36 and creates the content modules 14 provided for use in the performer 18 such as by a sales team using the performer via a digital storage cloud, VPN, or other networked communications devices. Limiting the editing of the content modules 14 to the composer 12 eliminates wasted time by sales persons in modifying presentation collateral for variations of content that may provide unsatisfactory or poor results based on non-uniform or inconsistent content different from organization standards.

The performer 18 allows access to the content modules 14 for selection and incorporation into the presentation assembly 20 and presents the content of the selected one of the presentation assembly 20 selectively in the non-linear presentation 44 based on the interactive dialog of participants rather than a monologue arising from a linear slide show event. The non-linear accessibility enables direct access to and presentation of appropriate and timely portions of the content elements based on the dialog, and thereby facilitates successful and effective closing of sales. The performer 18 assembles the selected content modules 14 in any order for creating customized pitches while also enabling selective presentation of the content modules during the pitch event 44. The performer 18 offers two presentation modes for (i) practice 40 and (ii) live pitch 44. The practice mode 40 allows the presenter to practice a presentation using the performer 18 such as for training, for preparing for the live pitch 44, or practicing a targeted development 42 responsive to the observed or determined gap between the tracked presentation criteria of the presenter and predetermined standards in order modify the presentation of the presentation assembly 20 for improved effectiveness. In live mode 44, the presenter must record the outcome (for example, closed, not closed, follow-up required) of the particular presentation pitch before the performer 18 may be used for a subsequent presentation.

The reporter 22 provides a metrics/measurement feature for collection, evaluation, and reporting outcomes of live presentation pitches, generates a filterable report allowing company management to view the presentation results by presenter (sales representative), outcome type, and date range. This information allows management to determine what specific training or targeted development 42 may improve the presentation or presenter's sales skills

The stand-alone composer 12, performer 18, and reporter 22 in this illustrative embodiment each have login and password screens (not illustrated) for secure access to the operational databases or library, as is conventional in the trade and no further discussion is necessary for creation and maintaining a system of user permissions and access controls.

The composer 12 operates to store and organize content elements 36. The content sources may be:

Images—including for example jpg, png, and bit map files

Attachment files—including for example, other presentation documents such as POWERPOINT documents, portable format documents, WORD documents and spreadsheet documents such as EXCEL documents

Video Files—MP4 files (for example, YOU TUBE format)

Web Site URLs

Content Module thumbnail

Other digital content files or data

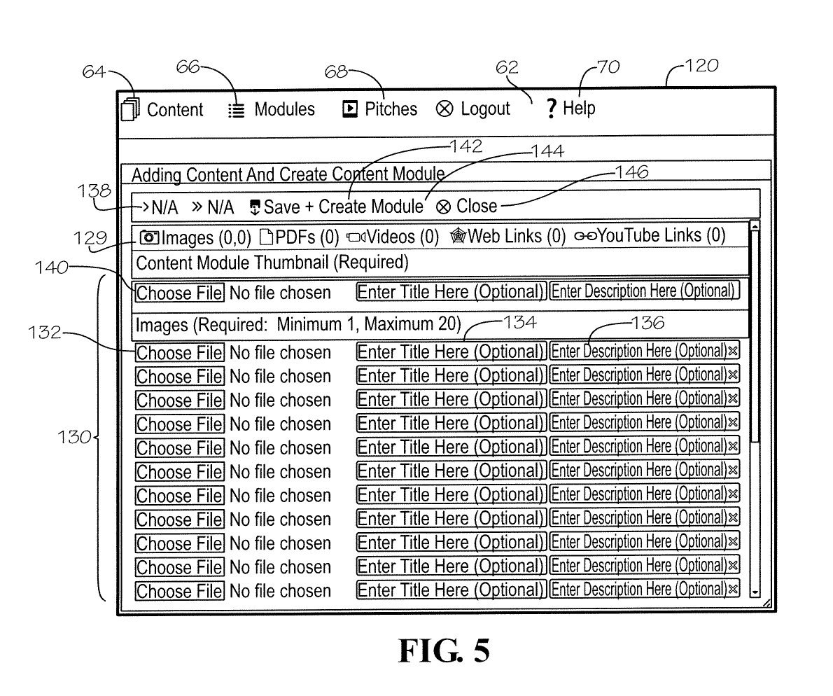

FIG. 5 illustrates a composer screen 120 for the composer 12 displaying a command bar 62 with selectable content button 64 (for add, change, or delete functions for content elements 36), modules button 66 (for add, change or delete content modules 14 containing content elements 36), and pitch button 68 (for add, change or delete pitch assembly 23). (Pitches 20 are generated by the presenter using the performer 18 while pitches 23 are created by the composer 12 as firm-standard pitch.) A content status window 129 includes icons for the images, attached PDF documents, videos, web links, and commercial video sites such as YOU TUBE links, together with the number of such items that are contained in that module. An alternate embodiment with editable attachments enabled includes appropriate icons for attachment files such as WORD and EXCEL documents.

The content button 64 presents the content elements screen 120 for adding content elements, changing content in a selected content element, or deleting a content element. Adding content may be (1) add content from a content source file and create a content module 14 or (2) add bulk content to add many files for content elements.

FIG. 5 further illustrates an add content window 130 that provides a browse button 132 for identifying a source file location (for example, on a local drive of a microprocessor based device), a title field 134 for entry of a short recognizable name for the content element, a description field 136 for entry of a more detailed explanation of the content element, and categories button 138 for a window to assign a searchable classification in association with the content. The categories or classification enable the use of filter descriptors for subsequent searching the library of content elements 37 for related content when creating a content module 14. The source file uploads to the library of content elements maintained on the electronic data storage device 33. The content elements 37 in the library 33 may subsequently be selected for including in a content module 14. The add content command may also create a content module 14 with only the then-uploaded content. A thumbnail browse field 140 identifies a source file location for a thumbnail image for the content element. The thumbnail image is used to provide a shorthand view of the content such as displayed when selecting content elements 14 in the composer 12 for including in a content module 14 or replacement when editing an existing content module, or, using the performer, for assembly of the pitch 20 or presentation of a selected pitch. The thumbnail gives a “heads-up” identification of the content that may be displayed or presented. A command bar provides save button 142, create module 144, and close 146. When the composer 12 is used in edit mode for a content element 37, the command bar also provides a save-as button.

The add bulk content uploads many same-type files in one operation. The file types available for bulk upload are the same discussed above for source file upload. The command buttons for bulk upland are similarly save, close, requirements, category 1 and 2 classifications, and file browse to locate the sources of the files for upload.

In addition, the content elements editing or maintenance include replace and delete action buttons. The replace button displays filtered (searched) content elements in a selection window. Selecting one of the content elements in the list opens the content elements window that displays the particular content(s) of the content element. Hovering with a selector or cursor over a selected one of the displayed elements presents file meta data (such as source file location, content size, and creation date, for example) and the description that was entered upon upload. Selecting the displayed element presents a review content window with review command buttons and a contents window having an image of the content (the thumbnail image), the source name, the title, the description, the image type, the image size, the date of upload, and a counter as to the number of content modules using the content element. The title, the description, and image type may be edited. A save button saves the changes made to the content element. A close button closed the review without entry of changes. A category 1 button and a category 2 button opens a widow for editing the classifications for the content element. A replace content button opens a window for browsing to a file source for uploading a replacement content. A delete button removes the content element from the library. However, if usage shows one or more content modules 14 using the content element 36, those content modules must be edited to remove the reference to the content element prior to deletion of the content module. A review usage button displays the names or titles of the content modules using the content element.

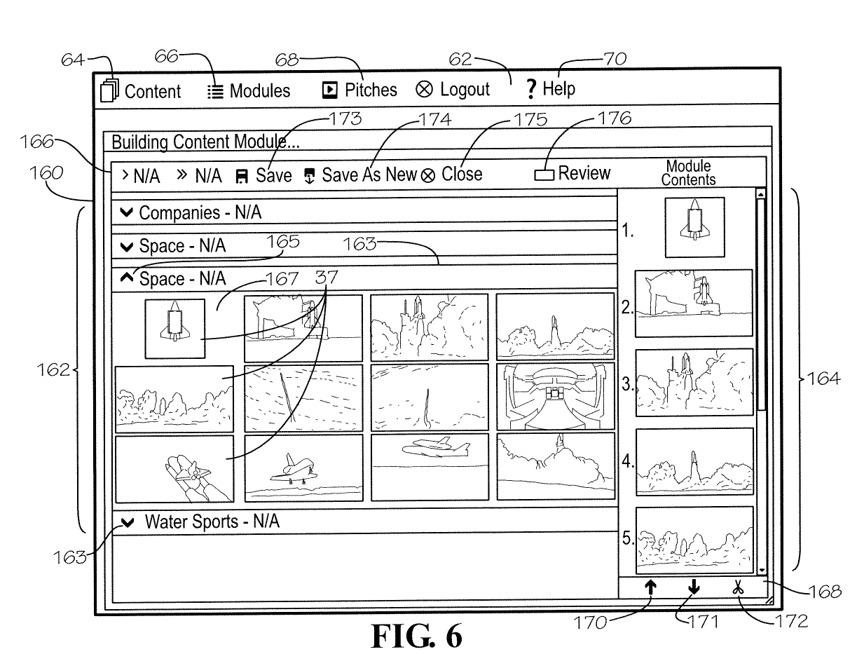

The content modules 14 are the building blocks of the presentation assemblies 20. The content modules 20 contain one or more content elements 14. The modules button 66 opens a modules window with selectable buttons for creating, editing, or deleting content modules 14. The create content module button opens a module screen 160 illustrated in FIG. 6 with a list window 162 that lists 163 uploaded content elements 14 and a module window 164 that displays the thumbnail associated with the particular listed content element. Content filter buttons 166 enables searching for selected content elements such as based on the category classification in order to list common content elements. An open/close arrow 165 associated with a selected one of the listed content elements 14 in the elements window 162 opens in a review portion 167 of the window the content element(s) 37 for review. A tool bar 168 includes directional buttons 170, 171 (up and down) to move the selected content element relative to the others for sequencing of the content elements in the content module. A scissors button 172 removes the selected content element 37 from the content module 14 during editing of a content module. A save button 173 saves the content module. This opens a screen for entry or modification optionally of the category 1 and 2 classifications associated with the content module, the content module name, the content module title, and a content module description (for example, during editing of a content module). The content name field is a short name for identifying the digital file of the content module. The title field is longer and includes more description for subsequent display such as during an activity with the performer 18 to remind the presenter of the content. The description may be displayed when a selector hovers over the displayed name of the content module.

The content modules may be edited with the composer 12 using the same process as building a content module discussed above. The order of the content elements 14 as shown in the list 162 may be changed. This is accomplished by selecting a particular listed content element 163 and operating the up or down control buttons 170, 171 to position the content element relative to the others in the list. The scissors button 172 deletes the selected content element from the content module. The save button 173 saves the edited content module. A save as new button 174 saves the edited content module with a new name and preserving the original content module without the edits. A close button 175 ends the editing process without making any changes to the content module. The scissors 172 deletes a selected content element from the library. However, the content module may not be deleted if one or more presentation assembly 20 reference the content module. A usage count may be displayed when hovering the cursor over the name of the content module in list of content modules or in a review content module screen. A review usage button 176 displays a list of the presentation assembly(ies) 20 that reference the particular content module 14 for selective use during presentations. Such presentation assembly 20 may be selected for editing to remove the reference to the content module, so that the content module may subsequently be deleted from the library.

The performer 18 allows sales representatives to assemble, edit, and present custom pitches 20 or present the pre-assembled pitches 23 which contain content modules 14. (The composer 12 accesses pitch assembly and edit functions with the pitch button 68.) The performer 18 may create custom pitches for presentation and edit or delete content modules from a local pitch. A pitch 23 created by the composer 12 may be copied (that is, opened for editing and saving as new local pitch) but may only be edited and saved in the database as changed by the originating composer.

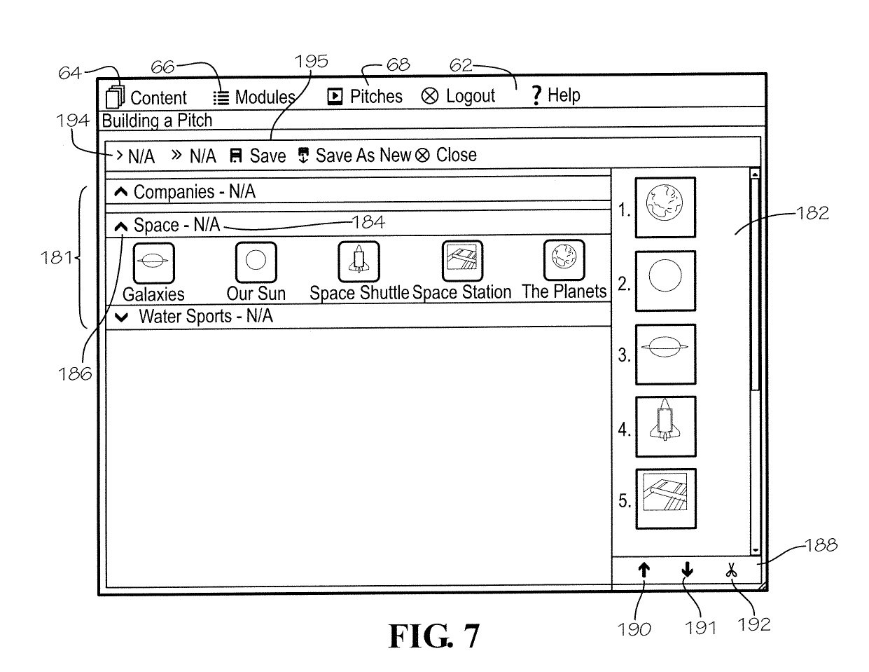

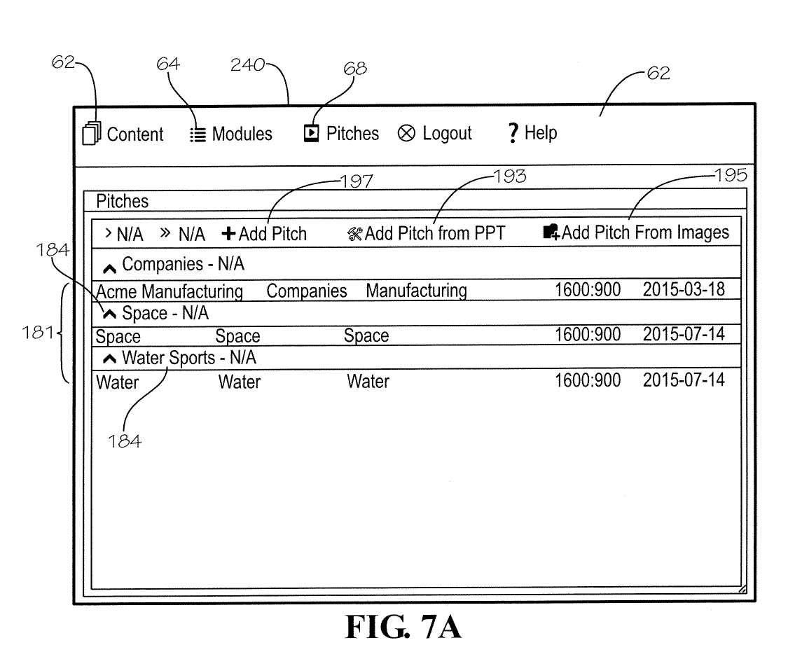

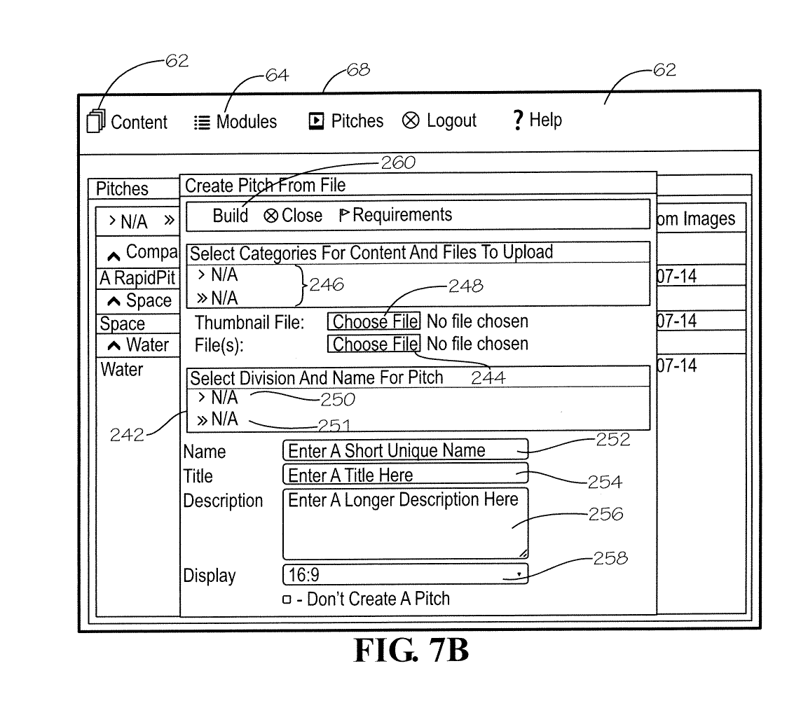

With reference to FIG. 7, the composer 12 opens to a functions screen 180 for pitches 20 for accessing pitches via button 68. A pitch development screen 181 lists content modules 14 and a window 182 for displaying the thumbnail associated with a particular listed content module. A list command line 184 for each listed content module 14 includes expand/hide button 186. The button 186 in the illustrated embodiment displays as an up arrow for opening and displaying the content elements of a selected one of the content modules and displays as a down arrow for closing the display of the content. A tool bar 188 includes order control buttons 190, 191 (move up, move down) to control the position of the content module relative to the others and a scissors button 192 to delete the selected content element from the sequence. It is noted here that although the pitch 20 is sequenced as selected by the person creating the pitch, during presentation of the content modules the presenter readily moves non-linearly among the content modules included in the pitch.

FIG. 7A illustrates a pitch creation window screen 240 that includes selectable buttons 197, 193, 195 to add a pitch 20 quickly from previously created content modules, from a PPT document, or from an images file, respectively, as may be necessary on occasion. The add pitch 197 button accesses the build pitch screen discussed above for FIG. 7. FIG. 7B illustrates a window 242 accessed through the buttons 193, 195 for adding a pitch from a source file specified in a browse field 244 for a PPT or images document. The window 242 includes appropriate fields for entering the content information needed to create or build a pitch. A pitch created through the window 242 has only one content module. The window 242 includes select buttons 246 for assigning category 1 or category 2 filter classifications, a browse button 248 for the thumbnail file, the browse select button 244 for the source file of the content 36, select buttons 250, 251 for the pitch module division 1 and division 2 filter classifications, the pitch name 252, title 254, and description 256. For images, a display ratio selection 258 has a dropdown menu for selecting screen ratio. Upon selecting a build button 260, the performer 18 assembles a new pitch 20 using the PPT document or the image document sourced from the file named in the browse field 244.

With continuing reference to FIG. 7, filter buttons 194 enables a group of content modules in the library to be listed based on a common classification of the content module. After the content modules 14 are selected and sequenced, the save button 196 saves the pitch assembly 20. A save pitch window (not illustrated) provides optionally a division 1 and a division 2 classifier fields, a name field that provides for entry of a short unique name for the particular pitch assembly, a title, a description, and a selected aspect ratio for the presentation of graphics, video, and images of the content on a display. These information fields enable organization, retrieval, and display of particular pitch 20 for pitch presentation to prospective customers 16.

A selected pitch 20 may be edited for adding, re-sequencing, or deleting content modules 14 using the control buttons on the tool bar 188. Content may be added by opening a window that lists available content modules, such as according to a selected filter based on the division 1 or division 2 classifications. Upon completion of editing, the pitch 20 is saved, or alternatively, the save as button 198 creates a new pitch and closes the original without the edited changes. The save-as button 198 further present the save pitch window for entry of the pitch name, title and description as noted above.

The scissors button 192 removes a selected pitch from the digital library of pitches. This is accomplished by presenting a delete screen (not illustrated) that presents the content thumbnail as well as the name, title and description of the pitch. A delete pitch button on the delete screen removes the pitch. In the illustrative embodiment, a confirmation is required before the pitch is removed. It is to be noted that the content modules formerly within the particular deleted pitch remain accessible in the library of content modules for use in other pitches. The usage counter is adjusted to reflect the deletion of the pitch using the particular content module.

In the illustrative embodiment, the composer 12 may edit content modules within the pitch build and pitch edit operation. Otherwise, the content modules are locked from modification by sales representatives or others using the performer 18.

Both the content modules 14 and the pitches 20 have respective associated classifiers discussed above for filtering during retrieval and use. The composer screen may include a classification button for access to a window for classifier commands. These commands include open, create, assign, or change classifications associate with respective content modules or pitches. The open command filters based on a selected category 1 or category 2 (content) or division 1 or division 2 (content modules and pitches). The create command allows defining a new classification for assignment and filtering. A screen opens for entry of an identification code, name and description of the classification. This screen has a save button and a cancel button. The new classification may be added to the list of available classifications using the saver button. The cancel button cancels the proposed new classification. The assign button allows assigning a classification to the content module or to the pitch 20. The change command enables editing of an assigned classification by replacing with a selected one of the classifications available for content module or pitch as appropriate. In the illustrative embodiment, an administrator attends to deletion of a classification from the list of available classifications.

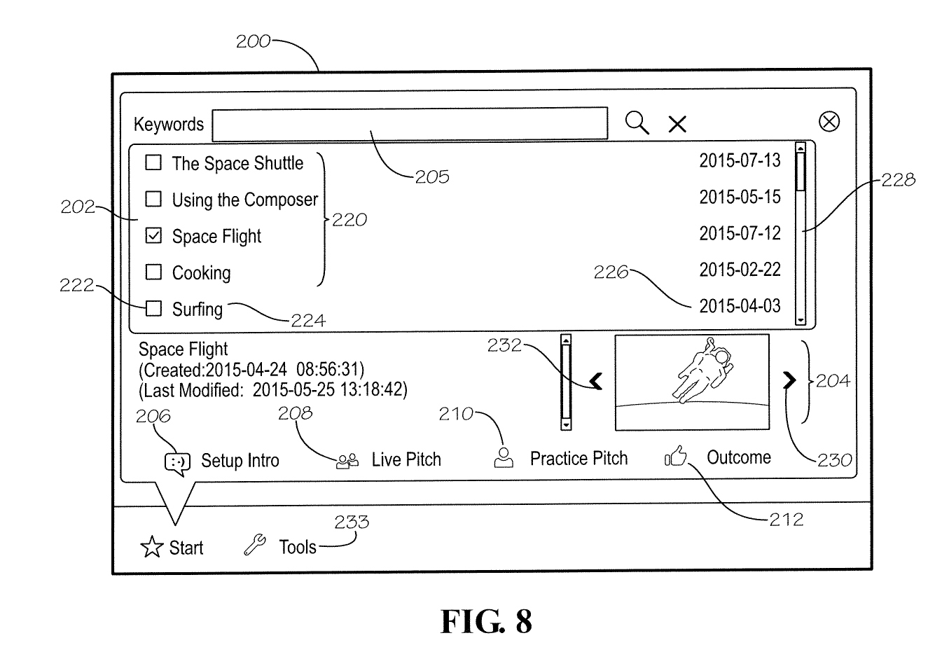

Selected pitches 20 may be presented to prospective or existing customers. FIG. 8 illustrates a performance pitch setup and select screen 200 accessed after login credentials processing. The screen 200 includes a pitch list window 202, a pitch preview window 204, a search field 205 for entry of terms for searching the pitch library, and command buttons for setup 206, live pitch mode 208, practice mode 210, and outcome 212. The pitch list window 202 displays a list 220 of pitches 20 in the library. The list includes for each pitch 20 a select box 222, the pitch name 224, and creation date 226. In an alternate embodiment, the division 1 and division 2 classifications are presented. A scroll bar 228 allows selective movement through the listed pitches 20. The preview window 204 displays an introductory slide and thumbnail associated with contents of a selected one of the pitches 20 in the list 220. File control arrows 230, 232 however selectively present in the preview window 204 the content modules content associated with the selected pitch. A tool window 233 opens the tools window 106 (see FIG. 4) with the select update button 106g for updating the content of the selected pitch directly from the library and a help button accessing the help files.

A new pitch is registered with the presentation library by the setup intro button 206. This opens a welcome screen builder (not illustrated) with fields for entry of the customer name, the location of the pitch, and optionally an introduction message personalized to the prospective customer such as a welcoming message, date, time, attendees and other notes for the presentation. Other screens (not illustrated) enable modification of the typeface, font and color. The pitch may then proceed as a live pitch or return to the start screen.

With continuing reference to FIG. 8, the live pitch button 208 becomes active after the outcome of the previous live pitch has been entered to the reporter 22. The live pitch button 208 resets the performer 18 for conducting the next pitch. The practice pitch button 210 allows the presenter to use the performer 18 without making a formal presentation such as for training or rehearsal. The outcome button 212 becomes active upon completion of the scheduled presentation.

The live pitch button 208 opens the performer screen shown in FIG. 4 discussed above with the display window 80 for operating the presentation of content elements from the content modules 14 included in the pitch 20. The performer 18 includes the display window 82 and the menu 84 of content module icons for selective access to content elements and features. A tool bar enables access to content:

Tools On Tool Bar To Access Content

| Icon | Reference | Description |
|---|---|---|
| movie camera | video 94 | Opens video files or video file links |
| paper sheet | notes 96 | Opens the attached PDF documents linked |
| | | to that content module |
| spider web | | Provides access to pre saved URL links |
| | | or a direct access to the web without |
| | | leaving the performer if the application |
| | | is online. |
| call out | | Opens a window (not illustrated) that |
| | | presents text or description information |
| | | about the content module (if populated in |
| | | association with the content module in the |
| | | library) |
| | spreadsheet | Allows the presenter to calculate pricing |
| | | of a product or products with a content |
| | | module that optionally includes a product |
| | | spreadsheet such as for order and |
| | | quotations |
| “thumbs-up” | content send | Allows the performer to send screen shots |
| | button 100 | or stored PDF files with a formatted email |
| | | from within the application without leav- |
| | | ing the application. |

The tools 106 in the performer command banner includes a wrench, a return button, and a logo for the performer system. The wrench button links to commands for pitches:

pitch library 106a—opens the library of available pitches 20 for selection and presentation

custom pitch 106b—provides a list of the content modules available in the library from which a user may select one or more individual content modules in a selected order for use in a pitch either immediately or in a pitch for later presentation

jump to new pitch—(available in an alternate embodiment), allows opening a pitch different from the pitch that is then being presented; opens pitch library screen for selection of an available pitch for immediate presenting

resume previous pitch 106c—causes return to the previous pitch (if additional pitches have been opened)

restart pitch 106d—performer 18 returns presentation to the beginning of the current pitch

start over 106e—performer 18 returns to start screen depicted in FIG. 8

save custom pitch 106f—performer 18 saves the current pitch as a new pitch; brings up pitch information page discussed above for entry of pitch name, title and description

intro—opens the current Welcome screen and the user may either start presenting the current pitch or select start over with transfer to creation of welcome screen for a pitch presentation event

update button 106g—updates the content of the selected pitch directly from the library

zoom 106h—enlarges the displayed image on the screen 82

help 106i—accesses the help files (may be stored on the microprocessor device 19 or on-line from the database 33).

Returning to FIG. 8, the outcome button 212 in the illustrated embodiment displays an outcome entry window (not illustrated). This window also displays upon start-up of the performer 18 if the outcome of the prior presentation has not yet been updated to the reporter 22 and the presentation tracking database. The outcome window has fields for the name associated with the pitch (i.e., the prospective customer name or customer to whom the pitch was presented), the location, and the outcome. The outcome is selected from a drop-down menu and may include:

awarded the business—sales follow-up on implementing

evaluation requested—presentation to be reviewed for possible targeted development

additional presentation requested—follow-up action by the sales representative required

additional information requested—follow-up action by the sales representative required

no progress from presentation—sales team review and analysis for further action

will let us know at later date—follow-up action by the sales representative required

lost business—sales team review and analysis for further action

Other criteria may be specified by a particular use of an embodiment of the present invention.

As illustrated in FIGS. 1 and 2, the composer 12, the performer 18 and the reporter 22 are separate applications within the system 10. The composer 12 uploads selected content items 36 for content elements 37, combines content elements 37 into content modules 14, and combines content modules 14 into pitches 23. The performer 18 may also access content modules 14 for creating pitches 20 and may access pitches 23 for presentation events at which the content elements in the content modules 14 in the pitch module 20 are displayed. A presenter may save a created pitch 20. The reporter 22 receives pitch metrics and makes available to management 24 information as to pitch presentations, from which training and targeted development may be used for modifying presentation performance and improving presenter skills.

The following figures relate to actions available with the composer 12:

FIG. 5 illustrates the composer 12 main screen during add content elements 37.

FIG. 3 illustrates the composer 12 main screen during a build content module 14 with the category “Space” filter open to show the available content element that may be selected for including in a content module.

FIG. 6 illustrates the composer 12 main screen during build or edit content module with a category filter open and selected content elements displayed in the content module window 164.

FIG. 7 illustrates the composer 12 main screen during build or edit of a pitch with the content module for “Space” open to display the content elements.

FIG. 7A illustrates the composer 12 main screen with division filters of available content modules.

FIG. 7B illustrates the composer 12 main screen with the window 242 open for creating a pitch from source files.

The following figures relate to actions available with the performer 18:

FIG. 8 illustrates the performer 18 main screen from which a presenter may select from the list 220 the pitch to present, to setup 206 an introduction for the particular presentation, to preview in a window 204 content of the selected pitch, to enter a live pitch 208, to enter a practice pitch 210, and to report the presentation outcome 212.

FIG. 4 illustrates the performer 18 presentation screen with the table of contents window 106 open for selective operations during the pitch event.

FIG. 4A illustrates the performer 18 with the send content window 111 open in response to the send content button 100.

It is to be appreciated that computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The pitch presentation apparatus and method can be a component of a single system, multiple systems, and/or geographically separate systems. The pitch presentation apparatus and method can also be a subcomponent or subsystem of a single system, multiple systems, and/or geographically separate systems. The pitch presentation components can be coupled to one or more other components (not shown) of a host system or a system coupled to the host system.

One or more components of the pitch presentation apparatus and method and/or a corresponding interface, system or application to which the pitch presentation apparatus is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistant devices, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the pitch presentation apparatus and method can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include but are not limited to, removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the pitch presentation apparatus and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the pitch presentation apparatus and method and corresponding systems and methods include: microcontrollers with memory (such as electronically erasable programmable read only memory (EEPROM)), embedded microprocessors, firmware, software, etc. Furthermore, aspects of the pitch presentation apparatus and method and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the pitch presentation apparatus and method and the corresponding systems and methods is not intended to be exhaustive or to limit the systems and methods to the precise forms disclosed. While specific embodiments of, and examples for, the pitch presentation apparatus and method and corresponding systems and methods are described herein for illustrative purposes, various equivalent modifications are possible within the scope of the systems and methods, as those skilled in the relevant art will recognize. The teachings of the pitch presentation apparatus and method and corresponding systems and methods provided herein can be applied to other systems and methods, not only for the systems and methods described above. The elements and actions of the various embodiments described above can be combined and/or modified to provide further embodiments. These and other changes can be made to the pitch presentation apparatus and methods and corresponding systems and methods in light of the above detailed description and without departure from the scope and spirit of the appended claims.

What is claimed is:

1. A systematic methodology for controlled creation of content and organization of selected content for presentations, comprising the steps of:
(a) creating with a composer, and storing, a plurality of content modules, each content module containing at least one content item and upon storing thereof locking the content module from change except by the composer; and
(b) accessing the plurality of content modules by a performer for selective access and display of the content items in a non-linear presentation,
whereby the locked content provides assurance of consistent content presentation while allowing for non-linear presentation responsive to a discussion between a presenter and a presentee.

2. The systematic methodology as recited in claim 1, further comprising the steps of:
(c) tracking the presentation according to one or more presentation criteria;
(d) determining an occurrence of a gap in the presentation based on the tracked criteria not meeting a predetermined standard; and
(e) creating a targeted development for modifying the presentation of the selected content modules.

3. The systematic methodology as recited in claim 2, further comprising the steps of repeating steps (c) and (d) after step (e).

4. The systematic methodology as recited in claim 1, wherein step (a) comprises selecting the content item from a plurality of source items.

5. The systematic methodology as recited in claim 4, wherein the source items comprises a plurality of text documents, graphics, videos, formatted documents, images, audio files, spreadsheet files, and data files.

6. The systematic methodology as recited in claim 1, further comprising the step of storing in an electronic storage device the selected content modules in an assembly as one of a plurality of presentation modules.

7. The systematic methodology as recited in claim 6, further comprising the step of accessing by a portable microprocessor device one or more of the assembled presentation modules and to display selectively the content modules thereof on a display device.

8. The systematic methodology as recited in claim 7, wherein the selective display of the content modules is non-linear.

9. The systematic methodology as recited in claim 8, further comprising the step of mandating entry of a record to a tracker file indicating a status of the displayed presentation before the performer may be operated for a subsequent access and display of one of the presentation modules.

10. The systematic methodology as recited in claim 2, further comprising the step of reporting presentations and tracked presentation criteria.

11. The systematic methodology as recited in claim 10, further comprising the step of adjusting at least one of the content modules based on the reported tracked presentation criteria.

12. The systematic methodology as recited in claim 1, wherein the linked content modules are stored in an electronic storage device that is accessed by the performer remote therefrom using a microprocessor based communications device through a communications network that communicates with the electronic storage device.

13. The systematic methodology as recited in claim 1, further comprising the step of selectively configuring the performer for a first operation mode for the targeted development.

14. A system providing controlled creation of content and assembly of selected content for a presentation, comprising:
(a) a composer configured for creating a content module containing at least one content item and for storing the created content module in a library holding a plurality content modules, each content module locked from change except by the composer;
(b) a communications network linking the library with at least one performer configured for accessing the plurality of content modules, displaying content modules selectively for review and selection for including in one of a plurality of presentation assembly maintained in the library; and
(c) the performer further configured for presenting the presentation assembly in a non-linear manner.

15. The system as recited in claim 14, further comprising:
(d) the performer further configured for tracking the presentation of the presentation assembly according to one or more presentation criteria;
(e) a reporter configured for receiving a value representative of the respective one or more tracked presentation criteria associated with the presentation and for determining an occurrence of a gap in the presentation based on the value of the respective tracked presentation criteria not meeting a predetermined standard; and
(f) a targeted development responsive to the gap fur modifying the presentation of the presentation module.

16. The system as recited in claim 15, further comprising the reporter configured for tracking the change in the difference between the valve of the tracked presentation criteria in a presentation subsequent to the modification of the presentation by the targeted development.

17. The system as recited in claim 14, wherein the composer selects the content item from a plurality of source items.

18. The system as recited in claim 17, wherein the source items comprise a plurality of text documents, graphics, videos, formatted documents, images, audio files, spreadsheet files, and data files.

19. The system as recited in claim 14, wherein the library comprises an electronic storage device for storing the plurality of content modules as accessible digital files.

20. The system as recited in claim 14, further comprising a classifier configured for assigning a searchable classification from a plurality of classifications to the content module.

21. The system as recited in claim 20, wherein the performer is configured for searching the library for identifying one or more of the content modules based on a selected one of the plurality of classifications.

22. The system as recited in claim 14, a portable microprocessor device configured with the performer.

23. The system as recited in claim 14, further comprising:
a presentation library for storing the assembled presentation as one of a plurality of presentation modules; and
the performer configured for selecting one of the plurality of presentation modules for presentation of the content modules thereof on a display device.

24. The system as recited in claim 14, wherein the presentation comprises non-linear selective display of the content modules.

25. The system as recited in claim 14, wherein the performer is configured for mandating entry of a record to a tracker file indicating a status of the presentation before the performer may be operated for a subsequent access and display of the content modules or presentation assembly selectively.

26. The system as recited in claim 15, wherein the reporter is configured for reporting of presentations and tracked presentation criteria.

27. The system as recited in claim 26, the composer further configured for changing at least one of the content modules based on the reported tracked presentation criteria.

28. The system as recited in claim 14, wherein the content modules are stored in an electronic storage device that is accessible by the performer remote therefrom using a microprocessor based communications device through the communications network.

29. The system as recited in claim 14, wherein the performer is selectively configuring for a first operation mode for the targeted development.

30. A networked system for presentation content configuration, usage in a presentation, and reporting based on presentation criteria, comprising:
(a) a microprocessor server device configured with an electronic memory device having a plurality of content elements that each comprise one or more content items, a plurality of content modules each comprising at least one content element, a plurality of a presentation assembly each comprising one or more selected ones of the content modules, and a status file of one or more presentation criteria values associated with a respective one of a plurality of presentations of the presentation assemblies;
(b) a communications network accessible to and communicating with the electronic memory device by
(i) a composer configured for maintaining the plurality of content elements and the plurality of content modules, each content module locked from change except by the composer,
(ii) a performer configured for maintaining the plurality of presentation assemblies, for display of a selected presentation assembly as a non-linear presentation displaying the content modules selectively, and for reporting to the status file a value representative of a respective one of the presentation criteria associated with the presentation for tracking of the presentation, and
(iii) a reporter configured for evaluating the presentation criteria values of the presentation relative to a predetermined presentation standard for each of the respective presentation criteria and reporting thereon; and
(c) a targeted development responsive to a gap in the presentation based on the tracked presentation criteria not meeting the predetermined standard thereof for modifying the presentation of the presentation assembly.

31. The system as recited in claim 30, further comprising the reporter configured for tracking the change in the difference between the valve of the tracked presentation criteria in a presentation subsequent to the modification of the presentation by the targeted development.

32. The system as recited in claim 30, wherein the composer selects the content item from a plurality of source items.

33. The system as recited in claim 32, wherein the source items comprise a plurality of text documents, graphics, videos, formatted documents, images, audio files, spreadsheet files, and data files.

34. The system as recited in claim 30, further comprising a classifier configured for assigning a searchable classification from a plurality of classifications to the content module.

35. The system as recited in claim 34, wherein the performer is configured for identifying for selection one or more of the content modules based on a selected one of the plurality of classifications.

36. The system as recited in claim 30, further comprising a portable microprocessor device configured with the performer.

37. The system as recited in claim 30, wherein the performer is configured for presenting the selected presentation assembly on a display device.

38. The system as recited in claim 30, wherein the performer is configured for mandating entry of a record to the status file before the performer may be operated fir a subsequent access to and display of the presentation assemblies.

39. The system as recited in claim 30, wherein the reporter is configured for reporting of presentations and tracked presentation criteria.

40. The system as recited in claim 39, the composer further configured for changing at least one of the content modules based on the reported tracked presentation criteria.

41. The system as recited in claim 30, wherein the content modules selected for grouping in the presentation assembly are accessible by the performer remote therefrom using a microprocessor based device through the communications network.

42. The system as recited in claim 30, wherein the performer is selectively configured for a first operation mode for the targeted development.
